(19) United States
(12) Patent Application Publication
(10) Pub. No.: US 2011/0199041 A1
(43) Pub. Date: Aug. 18, 2011

(54) RECHARGEABLE BATTERY PRODUCT

(76) Inventor: JERRY YANG, Irvine, CA (US)

(21) Appl. No.: 13/030,107

(22) Filed: Feb. 17, 2011

Related U.S. Application Data
(60) Provisional application No. 61/305,431, filed on Feb. 17, 2010.

(51) Int. Cl. H01M 10/46; H02J 7/00

(52) U.S. Cl. 320/101; 320/107

(57) ABSTRACT

A rechargeable battery product for a portable electronic device is disclosed. The case comprises a controller module detachably attached to a replaceable battery module. The battery module can be detached and charged from the controller module to provide continuous power to the device. The device can be powered simultaneously while recharging the battery module by connecting an external interface of the controller module with an external power source. The controller module further comprises an on/off switch that reduces the amount of power discharged from the battery when the portable electronic device is fully charged or when the battery is not in use and an indicator that indicates the remaining power of the battery module. The depleted battery module can be swapped with a new battery module to provide continuous power to the device for long time periods.

This application claims the benefit of U.S. Provisional Application No. 61/305,431 filed on Feb. 17, 2010.

### BACKGROUND OF THE INVENTION

1. Technical Field of the Invention

The present invention relates in general to battery products for portable electronic devices. More specifically, the present invention relates to a rechargeable battery product for a portable electronic device containing a replaceable battery module that can be detached and charged from a controller module.

2. Description of the Related Art

Many portable electronic devices (e.g., laptops, tablets, mobile phones, digital assistants, mobile communication devices, handheld computing devices, personal music/video/content players and storage devices) are often powered by battery power sources. Such battery power sources are often housed within the portable electronic device and may be changed and/or recharged as needed. However, as more powerful electronic devices are designed, these tend to consume power more quickly, thereby shortening the time between charges. This tends to limit the usefulness of the portable electronic device since the user must find a power source to recharge the battery source and wait until it is recharged.

In recent years external rechargeable battery products were designed to solve the above problem. In the case of a mobile device, these external rechargeable battery products house the device along with the rechargeable battery power sources and provide unlimited power to the device. The rechargeable battery products include a controller and a battery.

The lifetime of the external rechargeable battery product is typically limited by the lifetime of the battery built into the product. Most rechargeable batteries have an expected lifetime of 300 to 500 full charge cycles. Therefore, the rechargeable battery products are rendered useless when the battery wears out. In addition, the amount of time the rechargeable battery products can power the connected device is limited by the size of the installed rechargeable battery.

The current solution to alleviate the above problem is to discard the unusable rechargeable battery product and purchase a new one when the battery wears out. However, the above solution has significant disadvantages like electronic waste and the increased expenses associated with purchasing the new battery product. Further, new hardware features such as wireless charging and remote control capabilities cannot be added to the battery, without upgrading to a different battery.

Thus, there is a need for a rechargeable battery product containing a replaceable battery module which can be detached and charged from a controller module. Such a needed device would expand the lifetime of the rechargeable battery products, thus reducing electronic waste and saving the cost of purchasing a new battery case. This device would provide the user the convenience of being able to swap out depleted batteries for full batteries thereby enhancing the usability of the rechargeable battery product. Moreover, this needed device would provide the user the ability to upgrade the battery module to include new hardware features such as wireless charging and remote control capabilities, without rendering the controller obsolete.

### SUMMARY OF THE INVENTION

To minimize the limitations found in the prior art, and to minimize other limitations that will be apparent upon the reading of the specifications, the present invention provides a rechargeable battery product for a portable electronic device that comprises a controller module and a replaceable battery module. The replaceable battery module can be detached and charged from the controller module to provide continuous power to the portable electronic device. The controller module is detachably attached to the replaceable battery module. The controller module comprises an internal interface that engages a corresponding interface on the portable electronic device to provide power from the replaceable battery module to the device. The internal interface is coupled to an on/off switch, an indicator and an external interface, each provided at the bottom side of the controller module. The on/off switch is configured to reduce the power that is discharged from the battery when the portable electronic device is fully charged or when the battery is not in use and the indicator indicates the remaining power of the replaceable battery module.

The portable electronic device can be powered simultaneously while recharging the replaceable battery module by connecting the external interface with an external power source. The external interface further facilitates automatic syncing of the portable electronic device with a connected external device. The replaceable battery module, when depleted can be swapped with a new battery module to provide continuous power to the portable electronic device for long time periods thereby expanding the lifetime of the rechargeable battery product and reducing electronic waste. The usefulness of the rechargeable battery product can be enhanced by upgrading the battery module to incorporate new and future technologies such as wireless charging and remote control capabilities, without rendering the controller module obsolete.

One objective of the invention is to provide a rechargeable battery product for a portable electronic device comprising a replaceable battery module which can be detached and charged from a controller module.

Another objective of the invention is to provide a rechargeable battery product that allows for swapping out depleted battery modules for fully charged battery modules.

A third objective of the invention is to provide a sleek, compact and lightweight rechargeable battery product that effectively protects a portable electronic device from wear and tear.

Another objective of the invention is to provide a rechargeable battery product that allows for upgradation of the replaceable battery module to include new technologies.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention, illustrating a rechargeable battery product;

FIG. 2 is a perspective view of a controller module of the present invention;

FIG. 3 is a perspective view of a replaceable battery module of the present invention;

FIG. 4 is a perspective view of another embodiment of the present invention, illustrating a rechargeable battery product in an open position.

FIG. 5 is a perspective view of another embodiment of a controller module of the present invention.

FIG. 6 is a perspective view of another embodiment of a replaceable battery module of the present invention.

FIG. 7 is a perspective view of another embodiment of the present invention, illustrating a controller module detached from a replaceable battery module to remove a hand held communication device from within; and

FIG. 8 is a rear perspective view of another embodiment of the present invention, illustrating a rechargeable battery product with the hand held communication device inserted therein.

### DETAILED DESCRIPTION OF THE DRAWINGS

In the following discussion that addresses a number of embodiments and applications of the present invention, reference is made to the accompanying drawings that form a part of hereof, and in which is shown by way of illustration specific embodiments in which the invention may be practiced. It is to be understood that other embodiments may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

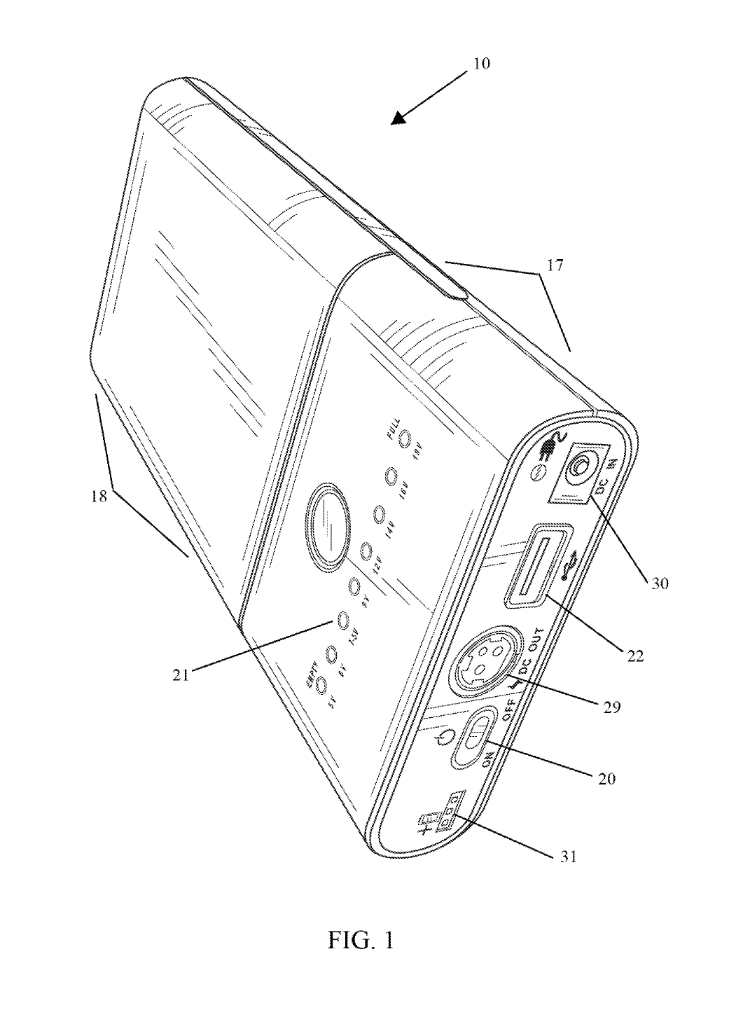

FIG. 1 shows a perspective view of a rechargeable battery product 10 for a portable electronic device (not shown). The rechargeable battery product 10 comprises a controller module 17 and a replaceable battery module 18. The replaceable battery module 18 can be detached and charged from the controller module 17 to provide continuous power to the portable electronic device (not shown). The controller module 17 comprises at least one internal interface 19. The at least one internal interface 19 is coupled to an on/off switch 20, an indicator 21 and a plurality of external interfaces 22, 29, 30, 31 each provided at the bottom side of the controller module 17.

The plurality of external interfaces 22, 29, 30, 31 may be a universal serial bus (USB) port, a multi-pin electrical connector port, a PS/2 connector, an auxiliary port, a solar panel and battery expansion port, and a power supply connector. The replaceable battery module 18 is recharged by connecting at least one external interface 30, 31 with an external power source (not shown). The portable electronic device (not shown) can be powered simultaneously while recharging the replaceable battery module 18. The plurality of external interfaces 22, 29 facilitate automatic syncing of the portable electronic device (not shown) with a connected external device (not shown). The at least one external interface 31 further facilitates the connection of an additional battery (not shown) to extend the overall capacity.

The on/off switch 20 is configured to reduce the power that is discharged from the battery when the portable electronic device (not shown) is fully charged or when the battery is not in use. The indicator 21 indicates the remaining power of the replaceable battery module 18.

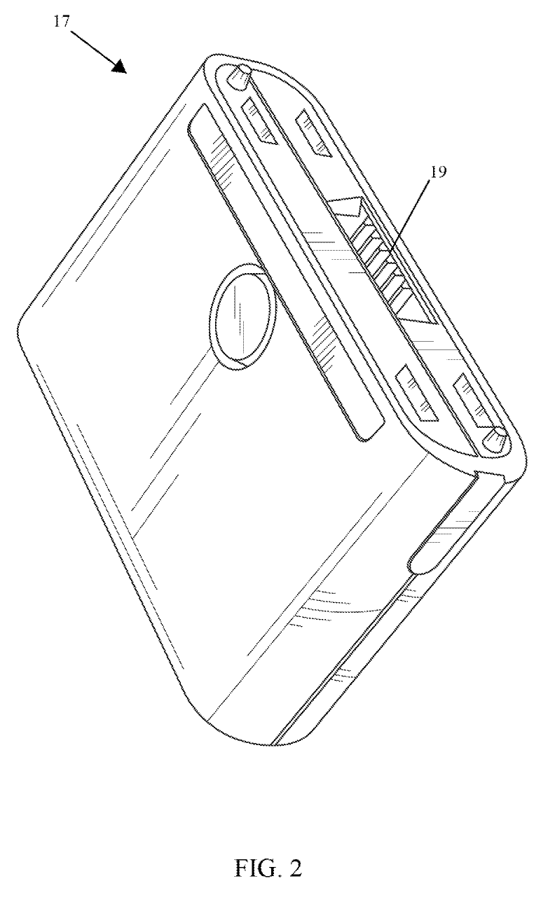

FIG. 2 shows a perspective view of a controller module 17 of the present invention. The controller module 17 is detachably attached to the replaceable battery module. The controller module 17 comprises at least one internal interface 19 to engage a corresponding interface on the replaceable battery module.

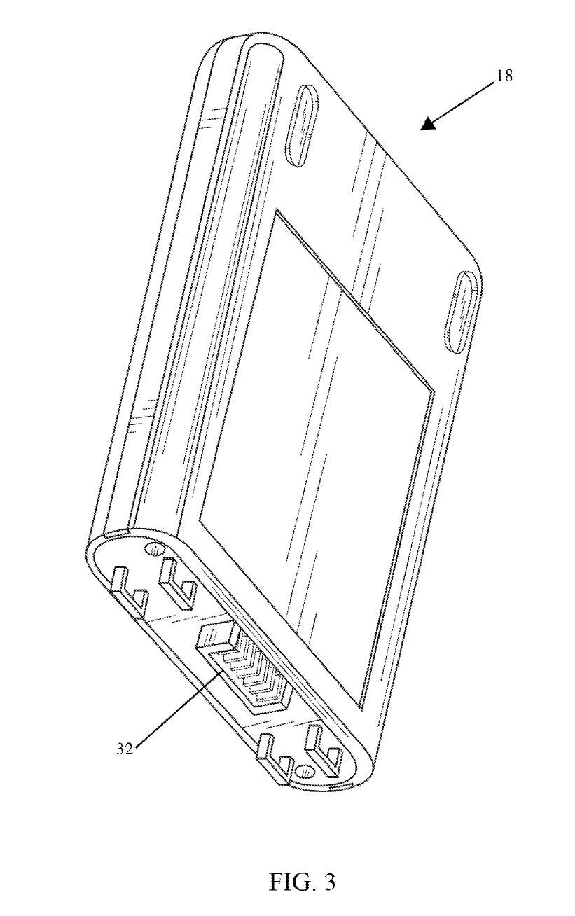

FIG. 3 shows a perspective view of a replaceable battery module 18 of the present invention. The replaceable battery module 18 is detachably attached to the controller module. The replaceable battery module 18 comprises at least one internal interface 31 to engage a corresponding interface, on the controller module.

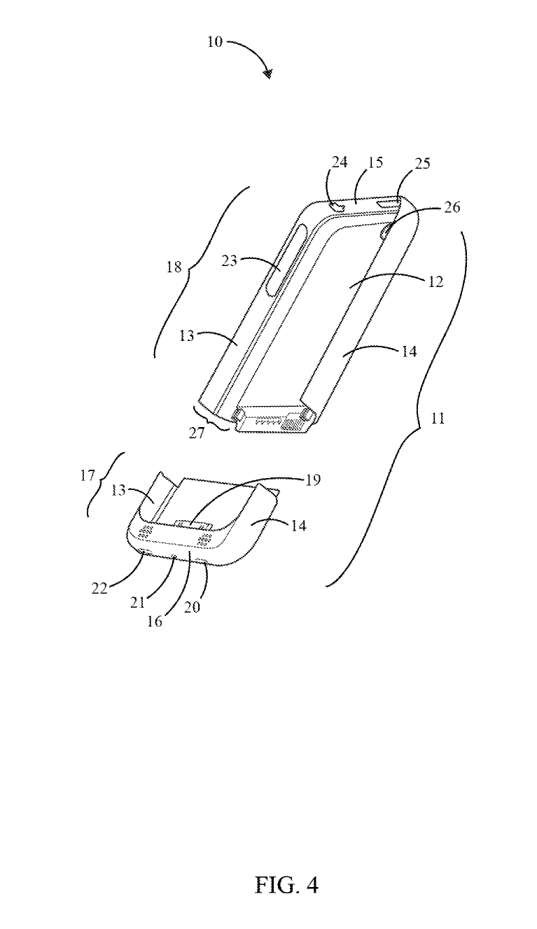

FIG. 4 shows a perspective view of another embodiment of a rechargeable battery product 10 for a hand held communication device (not shown) in an open position. The rechargeable battery product 10 comprises a housing 11 defining an inner cavity 12 having a left side surface 13, a right side surface 14, a top side 15 and a bottom side 16. The housing 11 comprises a controller module 17 and a replaceable battery module 18. The replaceable battery module 18 can be detached and charged from the controller module 17 to provide continuous power to the hand held communication device (not shown).

The housing 11 secures the hand held communication device (not shown) within the inner cavity 12 while at least one surface of the hand held communication device (not shown) remains exposed. The controller module 17 is detachably attached to the replaceable battery module 18. The controller module 17 comprises at least one internal interface 19 provided within the inner cavity 12. The at least one internal interface 19 is coupled to an on/off switch 20, an indicator 21 and at least one external interface 22, each provided at the bottom side of the housing 16. The replaceable battery module 18 comprises a plurality of openings 23, 24, 25 and 26 housed within the thickness 27.

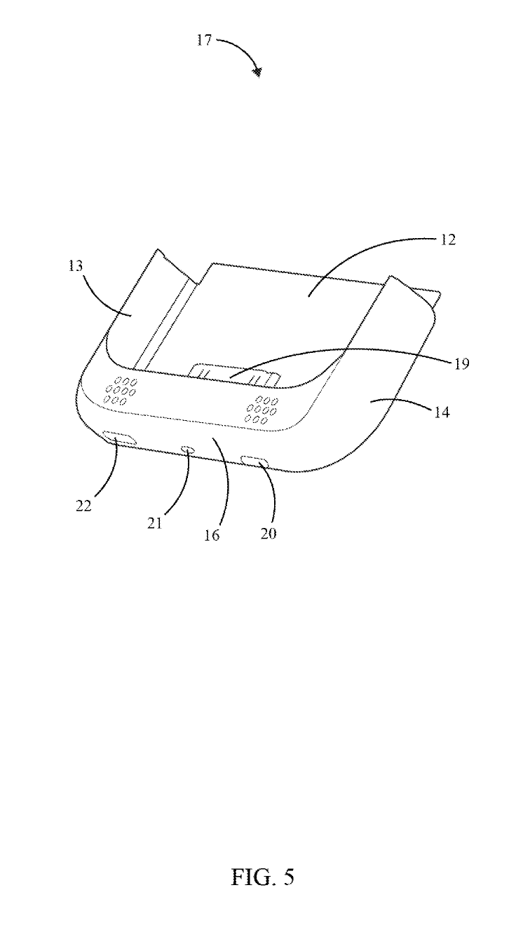

FIG. 5 is a perspective view of another embodiment of a controller module 17 of the present invention. The internal interface 19 engages a corresponding interface (not shown) on the hand held communication device (not shown) to provide power from the replaceable battery module 18 to the device (not shown). The at least one external interface 22 may be a universal serial bus (USB) port, a multi-pin electrical connector port, a PS/2 connector, an auxiliary port, or a power supply connector. The replaceable battery module 18 is recharged by connecting the at least one external interface 22 with an external power source (not shown). The hand held communication device (not shown) can be powered simultaneously while recharging the replaceable battery module 18. The at least one external interface 22 further facilitates automatic syncing of the hand held communication device (not shown) with a connected external device (not shown).

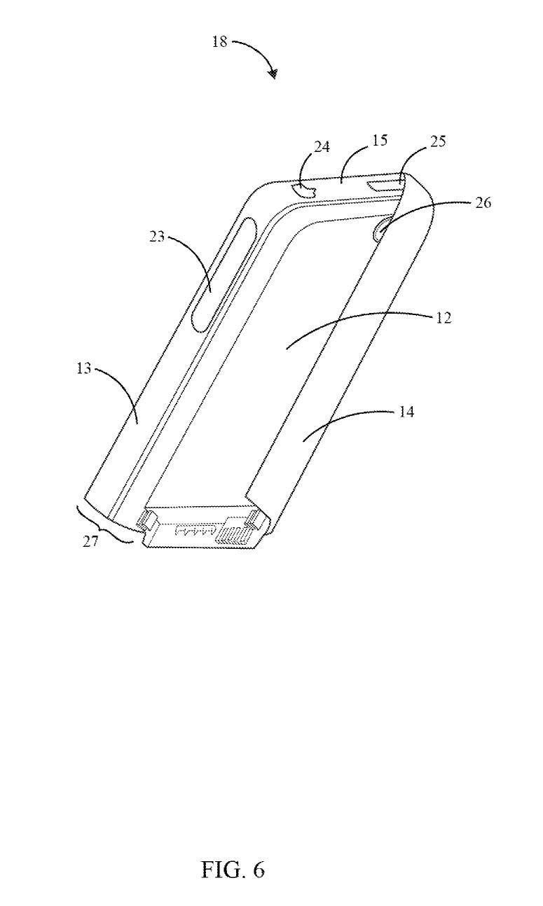

The on/off switch 20 is configured to reduce the power that is discharged from the battery when the hand held communication device (not shown) is fully charged or when the battery is not in use. The indicator 21 indicates the remaining power of the replaceable battery module 18 at a glance by means of a dual-color light-emitting diode. As shown in FIG. 6, the replaceable battery module 18 may be a lithium polymer battery. The plurality of openings 23, 24, 25 and 26 formed within the thickness of the replaceable battery module 27 facilitates easy access to integrated interfaces of the hand held communication device (not shown). The first opening 23 on the left side surface 13 provides access to a volume control switch. The second opening 24 on the top side 15 allows access to an audio jack on the hand held communication device (not shown). The third opening 25 on the top side 15 facilitates access to a screen on/off switch for the device (not shown). The fourth opening 26 on the inner cavity 12 provides unobstructed view for a camera lens located on a rear surface of the communication device (not shown).

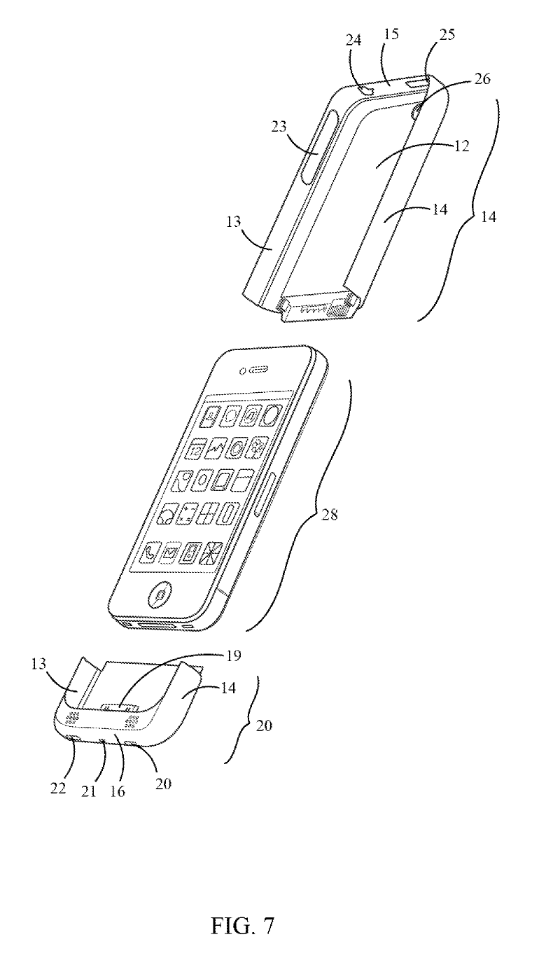

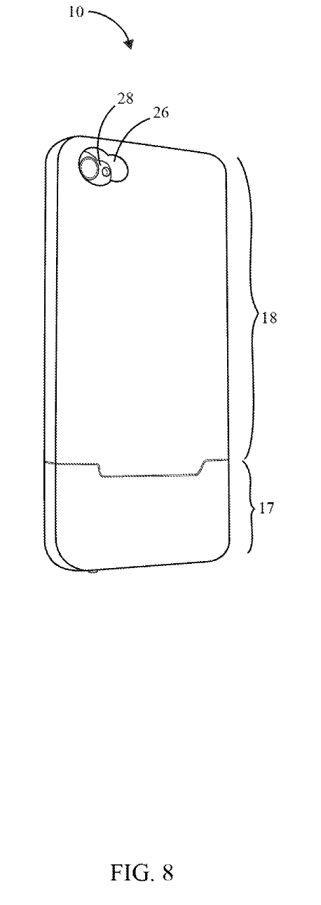

As illustrated in FIG. 7, another embodiment of a controller module 17 is detached from the battery module 18 to remove the hand held communication device 28 from within. The replaceable battery module 18 bypasses the battery and directly powers the communication device 28 rather than charging. The battery module 18 is inherent with battery safety features including built-in protection from over current, overcharging, over discharging, overheating and short circuiting. FIG. 8 shows a rear perspective view of another embodiment of the present invention. The replaceable battery module 18 and the controller module 17 are detachably attached to encase the hand held communication device 28 therein.

The replaceable battery module 18, when depleted can be swapped with a new battery module to provide continuous power to the hand held communication device 28 for long time periods thereby expanding the lifetime of the rechargeable battery product 10 and reducing electronic waste. The usefulness of the rechargeable battery product 10 can be enhanced by upgrading the battery module 18 to incorporate new and future technologies such as wireless charging and remote control capabilities, without rendering the controller module obsolete. The thickness of the battery case 10 is less than twice the thickness of the communication device 28 thereby making the device 28 more comfortable to hold. With a sleek, compact and lightweight design, the rechargeable battery product 10 elegantly wraps the hand held communication device 28 and serves as a protective case. The side surfaces and the back surface of the communication device are enclosed by the rechargeable battery product 10 thereby protecting the device 28 from wear and tear and enhancing the reception of the device 28.

The foregoing descriptions of the preferred embodiment of the present invention and an alternate embodiment of the invention have been presented for the purpose of illustration and description. It is not intended to be exhaustive or to limit the invention to the precise forms disclosed. Many modifications and variations are possible in light of the above teachings. It is intended that the scope of the present invention not be limited by this detailed description, but by the claims and the equivalents to the claims appended hereto.

What is claimed is:

1. A rechargeable battery product for a portable electronic device comprising:
a controller module and a replaceable battery module;
whereby the replaceable battery module can be detached and charged from the controller module to provide continuous power to the portable electronic device.

2. The rechargeable battery product of claim 1 wherein the controller module is detachably attached to the replaceable battery module.

3. The rechargeable battery product of claim 1, the controller module comprising at least one internal interface to engage a corresponding interface on the replaceable battery module.

4. The rechargeable battery product of claim 1, the controller module further comprising an on/off switch provided at one side and coupled to the internal interface to reduce the power discharged from the battery when the portable electronic device is fully charged or when the battery is not in use.

5. The rechargeable battery product of claim 1, the controller module further comprising an indicator provided at one side and coupled to the internal interface to indicate the remaining power of the replaceable battery module.

6. The rechargeable battery product of claim 1, the controller module further comprising a plurality of external interfaces provided at the bottom side and electrically coupled to the internal interface to provide power from the replaceable battery module to the portable electronic device.

7. The rechargeable battery product of claim 6, wherein the plurality of external interfaces may comprise a universal serial bus (USB) port, a multi-pin electrical connector, a PS/2 connector, an auxiliary port, and a solar panel and battery expansion port.

8. The rechargeable battery product of claim 6, wherein at least one external interface is a power supply connector configured to recharge the replaceable battery module when connected to an external power source.

9. The rechargeable battery product of claim 7, wherein at least one external interface is a solar panel and battery expansion port configured to recharge the replaceable battery module when connected to a solar panel.

10. The rechargeable battery product of claim 7, wherein at least one external interface is a solar panel and battery expansion port configured to allow the connection of an additional battery to extend the overall capacity.

11. The rechargeable battery product of claim 6, wherein at least one external interface is configured to automatically sync the portable electronic device to an external device.

12. The rechargeable battery product of claim 1 wherein the battery case simultaneously provides power to the portable electronic device while the replaceable battery module is being charged by the external power source.

13. The rechargeable battery product of claim 1 wherein the replaceable battery module, when depleted can be swapped with a new battery module to provide continuous power to the portable electronic device for long time periods thereby expanding the lifetime of the rechargeable battery product.

14. The rechargeable battery product of claim 1 wherein the replaceable battery module may be a lithium polymer battery.

15. A rechargeable battery product for a portable electronic device comprising:
a housing defining an inner cavity having a left side surface, a right side surface, a top side and a bottom side, the housing comprising a controller module and a replaceable battery module;
whereby the replaceable battery module can be detached and charged from the controller module to provide continuous power to the portable electronic device.

16. The rechargeable battery product of claim 15 wherein the housing secures the portable electronic device within the inner cavity while at least one surface of the portable electronic device remains exposed.

17. The rechargeable battery product of claim 15, the controller module comprising at least one internal interface provided within the inner cavity to engage a corresponding interface on the portable electronic device to provide power from the replaceable battery module to the device.

18. The rechargeable battery product of claim 15, the replaceable battery module comprising a plurality of openings housed within the thickness to permit access to integrated interfaces of the portable electronic device.

19. The rechargeable battery product of claim 15, wherein the thickness of the battery case is less than twice the thickness of the portable electronic device.

20. The rechargeable battery product of claim 15, wherein the battery case is shaped to closely wrap around the portable electronic device and serves as a protective case.
